(19) United States
(12) Patent Application Publication
(10) Pub. No.: US 2016/0093257 A1
(43) Pub. Date: Mar. 31, 2016

(54) Method And Device Of Brightness Adjustment For Display

(71) Applicant: MediaTek Inc., Hsinchu City (TW)

(72) Inventor: Yi-Ruei Wu, Tainan City (TW)

(21) Appl. No.: 14/872,008

(22) Filed: Sep. 30, 2015

Related U.S. Application Data
(60) Provisional application No. 62/158,626, filed on May 8, 2015.

(51) Int. Cl. G09G 3/36; G09G 5/10

(52) U.S. Cl. CPC G09G 3/3607; G09G 5/10; G09G 2320/0233

(57) ABSTRACT

A method may involve obtaining a desired emitted brightness value for a brightness module or a display module implementable in a display device. The desired emitted brightness value may be between a first configured emitted brightness value and a second configured emitted brightness value of a plurality of configured emitted brightness values outputable by the brightness module. The second configured emitted brightness value may be higher than the first configured emitted brightness value. The method may also involve determining one of the first configured emitted brightness value and the second configured emitted brightness value to be an actual emitted brightness value outputted by the display module or the brightness module. The method may further involve determining a gain for adjusting brightness of an image content outputted by the display module to compensate a difference between the desired emitted brightness value and the actual emitted brightness value.

### CROSS REFERENCE TO RELATED PATENT APPLICATION

The present disclosure claims the priority benefit of U.S. Provisional Patent Application No. 62/158,626, filed on 8 May 2015, which is incorporated by reference in its entirety.

### TECHNICAL FIELD

The present disclosure is generally related to display devices and, more particularly, to techniques pertaining to brightness adjustment for display devices.

### BACKGROUND

Unless otherwise indicated herein, approaches described in this section are not prior art to the claims listed below and are not admitted to be prior art by inclusion in this section.

In general, a liquid-crystal display (LCD) device can be considered as having an upper layer and a lower layer. The upper layer typically includes a liquid crystal film and a polarization film for controlling the transmittance of light. The lower layer typically includes a backlight. A brightness module, e.g., a backlight control module, is usually provided to control the brightness of light emitted by the backlight. A content displayed by the LCD device is typically controlled by a display module. In particular, brightness of the displayed content can be adjusted by controlling the rotation of the liquid crystal of the liquid crystal film and transmittance of light through the polarization film.

Referring to FIG. 11, a LCD device 1100 includes a display module 1130 controlling an upper layer 1110 (e.g., LCD) of LCD device 1100, and a brightness module 1140 controlling the lower layer of a lower layer 1130 (e.g., backlight). The brightness of the light emitted by the backlight usually varies in a step-wise fashion. That is, there is a gap between every two adjacent levels of brightness of the light emitted by the backlight. High-cost backlights may have more granular steps (and hence a greater number of steps) in the variation of the brightness of the emitted backlight. Accordingly, finer adjustment in the brightness of light may be attainable and the variation of brightness from one level to another may be smoother. On the other hand, low-cost backlights tend to have coarser steps (and hence a smaller number of steps) in the variation of the brightness of the emitted backlight. Accordingly, undesirable flashes may be observed when adjusting the brightness from one level to another.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, techniques, methods, devices and systems for brightness adjustment for display. Advantageously, implementations of the present disclosure can achieve finer adjustment in the brightness of backlight in display devices such as LCD devices. For example, utilizing implementations of the present disclosure, adjustment of brightness of the light emitted by a low-cost brightness module may be smoother and more granular than that for a conventional low-cost brightness module.

In one aspect, a method may involve obtaining a desired emitted brightness value for a brightness module or a display module implementable in a display device. The desired emitted brightness value may be between a first configured emitted brightness value and a second configured emitted brightness value of a plurality of configured emitted brightness values outputable by the brightness module. The second configured emitted brightness value may be higher than the first configured emitted brightness value. The method may also involve determining one of the first configured emitted brightness value and the second configured emitted brightness value to be an actual emitted brightness value outputted by the display module or the brightness module. The method may further involve determining a gain for adjusting brightness of an image content outputted by the display module to compensate a difference between the desired emitted brightness value and the actual emitted brightness value.

In another aspect, a method may involve adjusting brightness of a light outputted by a brightness module or a display module implementable in a display device such that the brightness of the light changes in a first serrated fashion. In response to the adjusting of the brightness of the light outputted by the brightness module or the display module, the method may involve adjusting brightness of an image content outputted by the display module such that a transmitting rate of the display module changes in a second serrated fashion. The brightness module may be a backlight module.

In yet another aspect, a method may involve adjusting brightness of a light outputted by a brightness module or a display module implementable in a display device such that the brightness of the light outputted by the brightness module or the display module changes from a first configured emitted brightness value to a second configured emitted brightness value. The first configured emitted brightness value and the second configured emitted brightness value may be two adjacent configured emitted brightness values of a plurality of configured emitted brightness values of the brightness module. In response to the adjusting of the brightness of the light outputted by the brightness module or the display module from the first configured emitted brightness value to the second configured emitted brightness value, the method may involve adjusting brightness of an image content outputted by the display module implementable in the display device such that a transmitting rate of the display module increases or decreases during a transition time period between the first configured emitted brightness value and the second configured emitted brightness value. The brightness module may be a backlight module.

In still another aspect, a method may obtain a first emitted brightness value desired to be outputted by a brightness module implementable in a LCD device. The method may also select, according to the first level, from a plurality of available levels the brightness module is capable of outputting a second emitted brightness value to be outputted by the brightness module. Each of the available levels may be different from the first level. The method may further modify a brightness level of an image content outputted by a display module implementable in the LCD device to compensate a difference between the first level and the second emitted brightness value outputted by the brightness module.

In one aspect, an apparatus may include one or more processors and a memory device. The memory device may be coupled to the one or more processors and configured to store a plurality of components executable by the one or more processors. The plurality of components may include an acquisition module, a determination module and an adjustment module. The acquisition module may be configured to cause the one or more processors to obtain a desired emitted brightness value for a brightness module or a display module implementable in a display device. The desired emitted brightness value may be between a first configured emitted brightness value and a second configured emitted brightness value of a plurality of configured emitted brightness values outputable by the brightness module. The second configured emitted brightness value may be higher than the first configured emitted brightness value. The determination module may be configured to cause the one or more processors to determine a value of a driving level for driving the brightness module. The driving level may correspond to an actual emitted brightness value outputted by the display module or the brightness module. The actual emitted brightness value may be either the first configured emitted brightness value or the second configured emitted brightness value. The determination module may be further configured to cause the one or more processors to determine a gain for adjusting brightness of an image content outputted by the display module to compensate a difference between the desired emitted brightness value and the actual emitted brightness value. The adjustment module may be configured to cause the one or more processors to adjust the brightness of the image content outputted by the display module according to the gain.

In another aspect, an apparatus may include one or more processors and a memory device. The one or more processors may be configured to control operations of a brightness module and a display module implementable in a display device. The memory device may be coupled to the one or more processors and configured to store a plurality of components executable by the one or more processors. The plurality of components may include an acquisition module, a determination module and an adjustment module. The acquisition module may be configured to cause the one or more processors to obtain a first emitted brightness value desired to be outputted by the brightness module. The determination module may be configured to cause the one or more processors to select, according to the first emitted brightness value and from a plurality of available brightness levels the brightness module is capable of outputting, a second emitted brightness value to be outputted by the brightness module, wherein each of the available brightness levels is different from the first emitted brightness value. The adjustment module may be configured to cause the one or more processors to adjust brightness of an image content outputted by the display module to compensate a difference between the first emitted brightness value and the second emitted brightness value outputted by the brightness module.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of a general scheme of brightness adjustment for display in accordance with an implementation of the present disclosure.

FIG. 2 is a diagram of an example scheme of brightness adjustment for display in accordance with an implementation of the present disclosure.

FIG. 3 is a diagram of an example scheme of brightness adjustment for display in accordance with another implementation of the present disclosure.

FIG. 4 is a diagram of an example scheme of brightness adjustment for display in accordance with yet another implementation of the present disclosure.

FIG. 5 is a schematic diagram of an example algorithm of brightness adjustment for display in accordance with an implementation of the present disclosure.

FIG. 6 is a schematic diagram of an example algorithm of brightness adjustment for display in accordance with another implementation of the present disclosure.

FIG. 7 is a block diagram of an example apparatus in accordance with an implementation of the present disclosure.

FIG. 8 is a flowchart of an example process of brightness adjustment for display in accordance with an implementation of the present disclosure.

FIG. 9 is a flowchart of an example process of brightness adjustment for display in accordance with another implementation of the present disclosure.

FIG. 10 is a flowchart of an example process of brightness adjustment for display in accordance with yet another implementation of the present disclosure.

FIG. 11 illustrates a conventional LCD device and a conventional way of brightness adjustment for display.

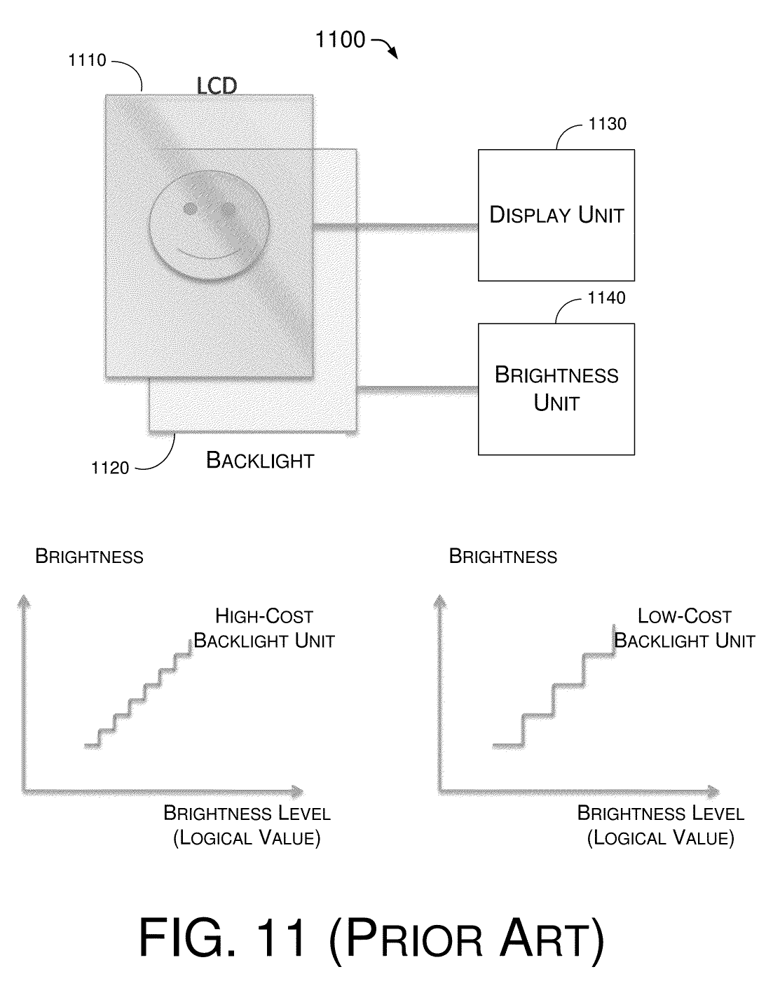

### DETAILED DESCRIPTION OF PREFERRED IMPLEMENTATIONS

### Overview

Implementations of the present disclosure allow replacement of high-cost brightness modules (or high-cost brightness driver integrated circuits) with low-cost brightness modules (or low-cost brightness driver integrated circuits) that produce effects approximately the same as those of the high-cost counterparts. As brightness of an image content of a display can be adjusted by way of image processing, the brightness of the image content of a display may be adjusted to interpolate additional steps, or granularity, in the variation of the brightness of the emitted brightness. Accordingly, by adjusting the brightness of the displayed image content, brightness modules (or brightness driver integrated circuits) having coarser steps (and hence a smaller number of steps) in the variation of the emitted brightness may be utilized to provide additional granularity, or steps, in the variation of the emitted light, thereby simulating the smooth, granular effects in brightness adjustment not achievable other than by high-cost brightness modules (or high-cost brightness driver integrated circuits). Moreover, when there are physical constraints for a given brightness module, above-described effects can still be simulated under the constraints with various implementations of the present disclosure.

It is noted that the brightness driver integrated circuits may mean backlight driver integrated circuits but not limited thereto. In addition, for different devices the brightness driver integrated circuits may be separated from display modules or integrated with the display modules (such as active-matrix organic light-emitting diodes, or AMOLED) and are not limited to any specific implementations in the disclosure.

The term “brightness module” herein may refer to a hardware component, including necessary circuitry, photonics and electronics, configured to control the overall brightness of a display module (e.g., a LCD display panel) in accordance with a driving level received as an input. In some implementations, a brightness module may be a backlight module that controls the overall brightness of a LCD display module. The output of the brightness module is not affected by the content of image displayed by the display module.

The term “brightness level” herein may refer to a representative value set by a system, which may be a logical value, and may be used for computation but not outputted to a driver circuit (e.g., a brightness driver integrated circuit) or any hardware component. According to the present disclosure, each “brightness level” may correspond to a respective emitted brightness value. The “brightness level” is not the same as and is independent from the content brightness of a display module.

The term “emitted brightness value” of the brightness module herein may refer to the physical (actual) brightness of a content of pure white color (with R, G, B=1.0, 1.0, 1.0) displayed on a screen or a display module, which may be the overall brightness directly controlled by the brightness module and measurable by instrument. The “emitted brightness value” herein may have a positive correlation with a respective “brightness level”. That is, the higher the “brightness level” is, the greater the “emitted brightness value” will be, and vice versa.

The term “desired brightness” herein may refer to the expected physical (actual) brightness, which may or may not be achieved by the brightness module. According to various implementations of the present disclosure, “desired emitted brightness value” may be achieved by adjusting the content brightness.

The term “driving level” herein may refer to the physical value of a signal used to control the hardware related to emission of light (e.g., brightness module and/or driver circuit).

The term “content brightness” herein may refer to the brightness of the image content of a display module. The “content brightness” is not affected by the “brightness” of the brightness module.

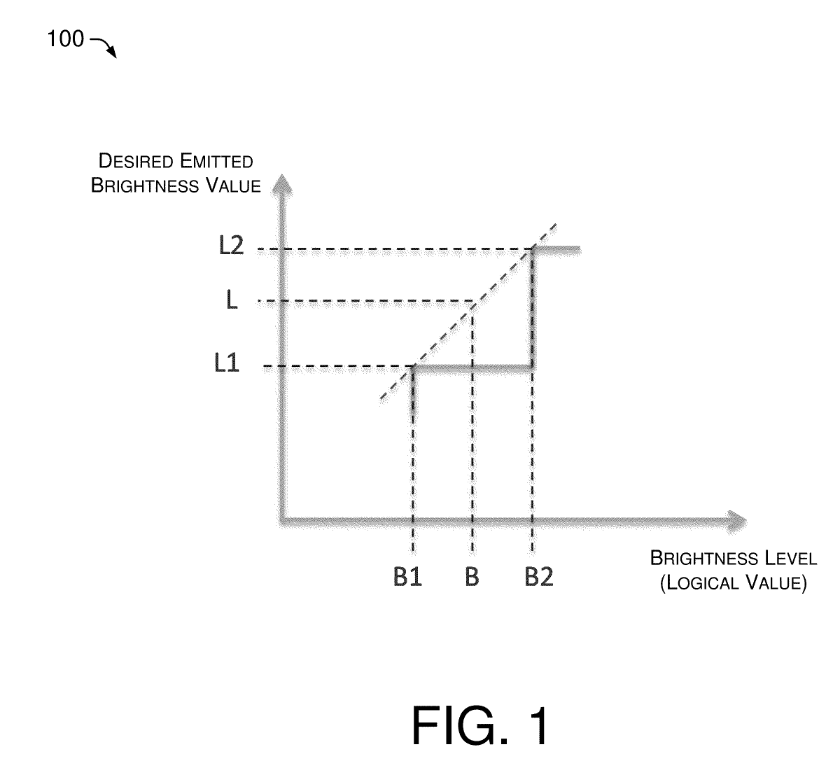

FIG. 1 illustrates a general scheme 100 of brightness adjustment for display in accordance with an implementation of the present disclosure.

Under general scheme 100, when a brightness level is set to the logical value B, the desired emitted brightness value is L. Additionally, under general scheme 100, the given brightness module (or the given brightness driver integrated circuit) is configured to output or otherwise emit a light, e.g., backlight, having a value of emitted brightness at either a first emitted brightness value L1 or a second emitted brightness value L2, with the first emitted brightness value L1 lower than L and the second emitted brightness value L2 higher than L. First emitted brightness value L1 and second emitted brightness value L2 correlate to first and second brightness levels of B1 and B2, respectively, with the first brightness level B1 lower than B and the second brightness level B2 higher than B. The correlation between the first emitted brightness value L1 and second emitted brightness value L2 and the first and second brightness levels of B1 and B2 may be obtained by actual measurement of the emitted backlight or, alternatively or additionally, may be provided by the vendor of the given brightness module (or the given backlight driver integrated circuit). With implementations of the present disclosure, the given brightness module (or the given brightness driver integrated circuit) can output or otherwise emit a light, e.g., backlight, having a value of emitted brightness at the desired emitted brightness value L. This may be achieved by one of a number of schemes or techniques including, but not limited to, a first scheme herein referred to as the “content-darkening scheme”, a second scheme herein referred to as the “content-brightening scheme”, and a third scheme herein referred to as the “mixed content-brightening-and-darkening scheme”.

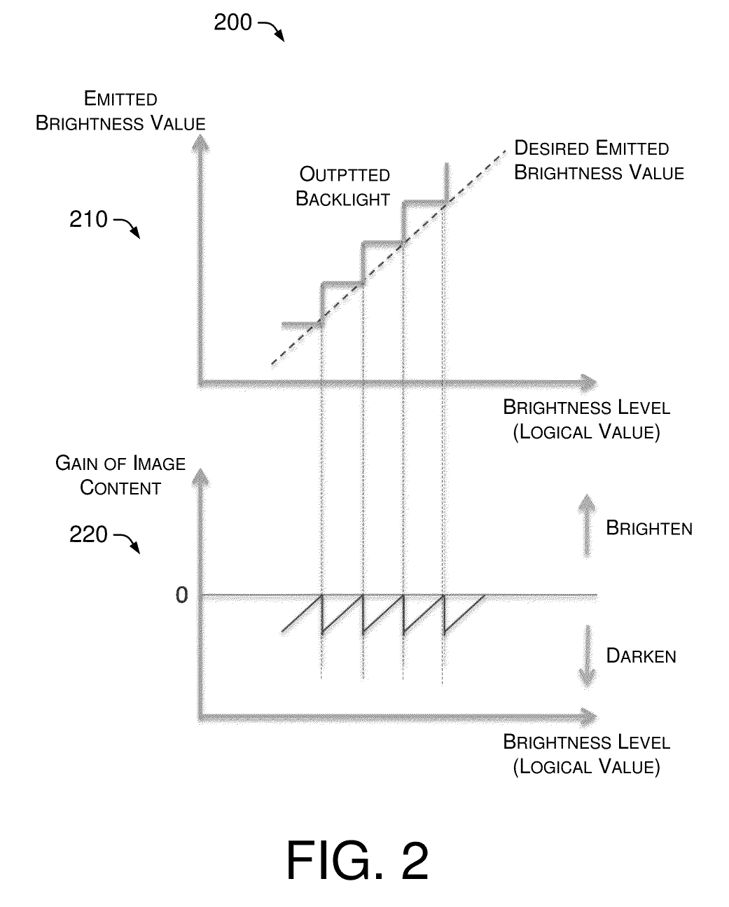

FIG. 2 illustrates an example scheme 200 of brightness adjustment for display in accordance with an implementation of the present disclosure.

Example scheme 200 is the “content-darkening scheme”. Under example scheme 200, when the brightness level for the given brightness module (or the given brightness driver integrated circuit) is set to the logical value B, the given brightness module (or the given backlight driver integrated circuit) outputs or otherwise emits a light, e.g., backlight, having brightness at the second emitted brightness value L2, correlating to the second brightness level B2. Additionally, under example scheme 200, the content brightness I of each pixel of the image content for display may be processed to become I′ with decreased brightness, thereby mitigating the effect of higher value of emitted brightness value outputted by the given brightness module (or the given brightness driver integrated circuit). This may be expressed mathematically as Equation 1 below.

I′=(L/L2)×I, with L/L2 less than 1 (1)

Referring to FIG. 2, chart 210 shows a relation between the emitted brightness value of outputted light (vertical axis) and brightness level (horizontal axis) of the given brightness module (or the given brightness driver integrated circuit). Chart 220 shows a relation between the gain for image content adjustment (vertical axis) and brightness level (horizontal axis). As shown in chart 210, variation in the brightness of the outputted light changes in a serrated, or step-wise, fashion, and the actual emitted brightness value of the outputted light is generally higher than the desired emitted brightness value, which is shown as a straight line in chart 210, for all brightness levels. Under example scheme 200, as shown in chart 220, the brightness of each pixel of the image content for display is adjusted lower, or darkened, so that the resultant brightness of the displayed image content may fall on the straight line of desired emitted brightness value for a given brightness level.

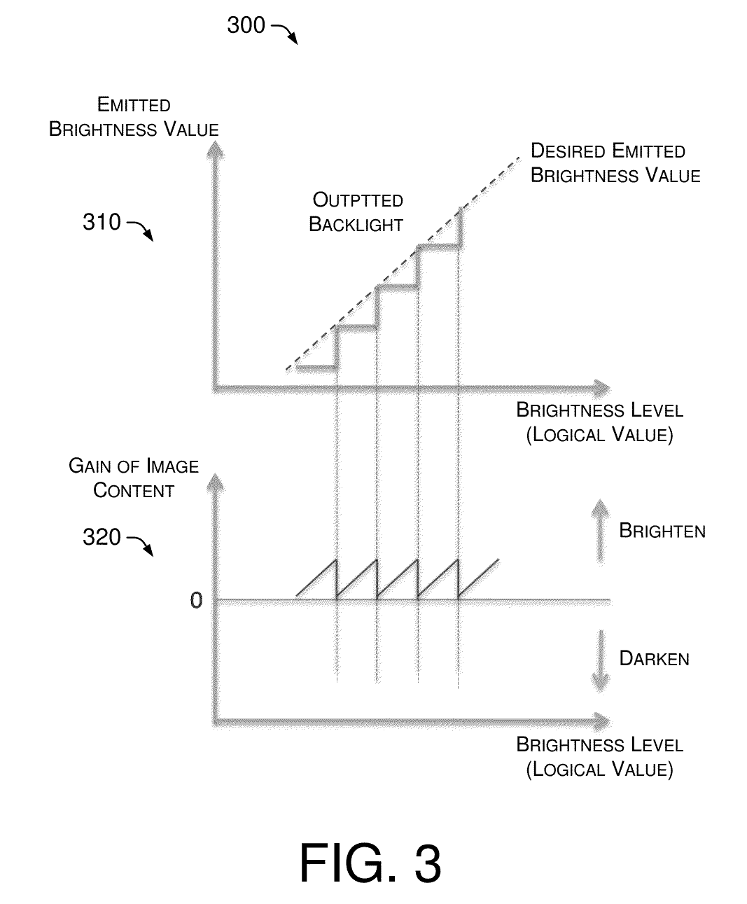

FIG. 3 illustrates an example scheme 300 of brightness adjustment for display in accordance with another implementation of the present disclosure.

Example scheme 300 is the “content-brightening scheme”. Under example scheme 300, when the brightness level for the given brightness module (or the given brightness driver integrated circuit) is set to the logical value B, the given brightness module (or the given brightness driver integrated circuit) outputs or otherwise emits a backlight having brightness at the first emitted brightness value L1, correlating to the first desired brightness level B1. Additionally, under example scheme 300, the content brightness I of each pixel of the image content for display may be processed to become I′ with increased brightness, thereby mitigating the effect of lower value of emitted brightness value outputted by the given brightness module (or the given brightness driver integrated circuit). This may be expressed mathematically as Equation 2 below.

I′=(L/L1)×I, with L/L1 greater than 1 (2)

Referring to FIG. 3, chart 310 shows a relation between the emitted brightness value of outputted light (vertical axis) and brightness level (horizontal axis) of the given brightness module (or the given brightness driver integrated circuit). Chart 3220 shows a relation between the gain for image content adjustment (vertical axis) and brightness level (horizontal axis). As shown in chart 310, variation in the emitted brightness value of the outputted light changes in a serrated, or step-wise, fashion, and the actual emitted brightness value of the outputted light is generally lower than the desired emitted brightness value, which is shown as a straight line in chart 310, for all brightness levels. Under example scheme 300, as shown in chart 320, the brightness of each pixel of the image content for display is adjusted higher, or brightened, so that the resultant brightness of the displayed image content may fall on the straight line of desired emitted brightness value for a given brightness level.

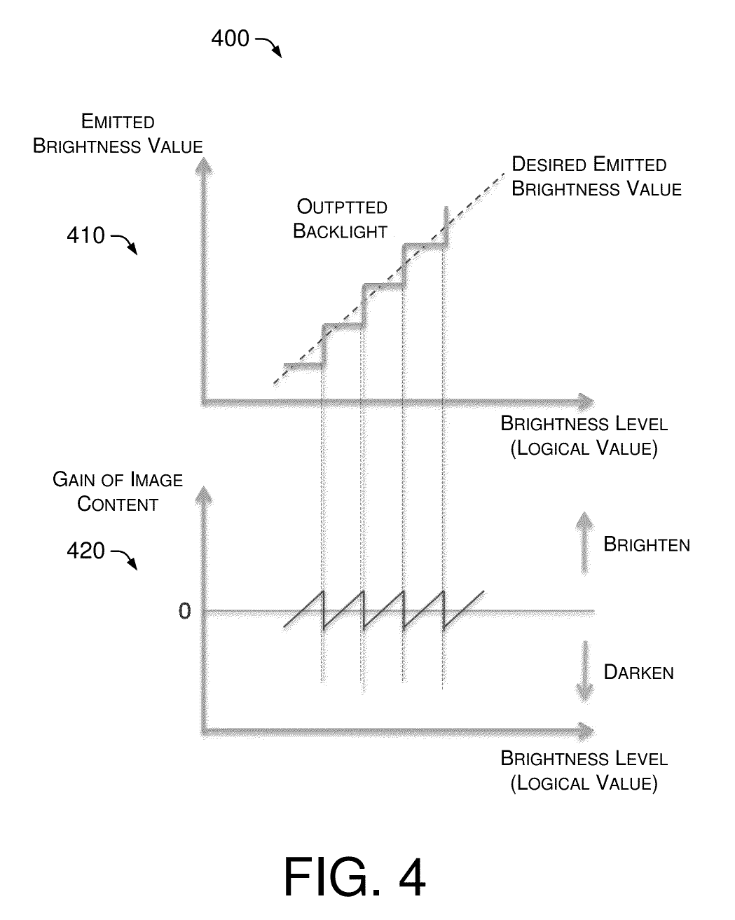

FIG. 4 illustrates an example scheme 400 of brightness adjustment for display in accordance with yet another implementation of the present disclosure.

Example scheme 400 is the “mixed content-brightening-and-darkening scheme”. Under example scheme 400, the content brightness I of each pixel of the image content for display may be processed to become I′ based on the actual value of emitted brightness value L′ outputted by the given brightness module (or the given brightness driver integrated circuit). This may be expressed mathematically as Equation 3 below.

I′=(L/L′)×I (3)

Referring to FIG. 4, chart 410 shows a relation between the emitted brightness value of outputted light (vertical axis) and brightness level (horizontal axis) of the given brightness module (or the given brightness driver integrated circuit). Chart 420 shows a relation between the gain for image content adjustment (vertical axis) and brightness level (horizontal axis). As shown in chart 410, variation in the emitted brightness value of the outputted light changes in a serrated, or step-wise, fashion, and the emitted brightness value of the outputted light is interleaved with the desired emitted brightness value, which is shown as a straight line in chart 410. That is, the actual emitted brightness value of the outputted light may be higher than the desired emitted brightness value for some desired brightness levels and lower than the desired emitted brightness value for other brightness levels. Under example scheme 400, as shown in chart 420, the brightness of each pixel of the image content for display is adjusted lower or higher, either darkened or brightened, so that the resultant brightness of the displayed image content may fall on the straight line of desired emitted brightness value for a given brightness level.

Gamma correction, gamma nonlinearity or gamma refers to a nonlinear operation used to code and decode luminance or tristimulus values in video or still image systems. In each of example schemes 200, 300 and 400, the effect of gamma may need to be taken into account in processing the pixels of the image content for display. In mathematical terms, let g be the gamma function of the content brightness I of each pixel of the image content for display, and g⁻¹ is the inverse function of g. Then, adjustment for gamma for the content brightness I of each pixel of the image content for display may be expressed mathematically as Equation 4 below.

I′=g(L/L′×g⁻¹(I)) (4)

Generally speaking, I′ is a function of L, L′ and I, as expressed mathematically as Equation 5 below.

I′=f(L,L′,I) (5)

### Example Algorithm

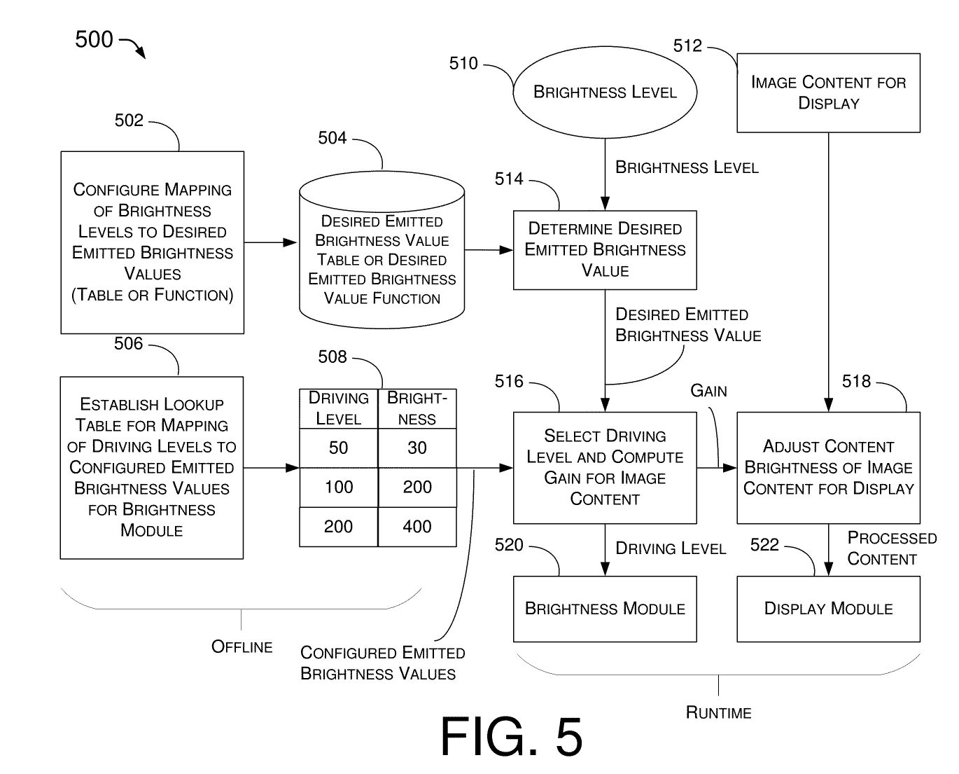

FIG. 5 illustrates an example algorithm 500 of brightness adjustment for display in accordance with an implementation of the present disclosure. Example algorithm 500 may involve one or more operations, actions, or functions as represented by one or more of operations 502, 504, 506, 508, 510, 512, 514, 516, 518, 520 and 522. Although illustrated as discrete blocks, various blocks of example algorithm 500 may be divided into additional blocks, combined into fewer blocks, or eliminated, depending on the desired implementation. Example algorithm 500 may be implemented by example apparatus 700 described below.

Referring to FIG. 5, a portion of example algorithm 500 may be accomplished offline while another portion of example algorithm 500 may be accomplished during runtime. At operation 502 of example algorithm 500, brightness levels may be set in either a table of desired emitted brightness value or in a function of desired emitted brightness value. At operation 504 of example algorithm 500, the table of desired emitted brightness value or function of desired emitted brightness value may be stored, e.g., in a memory device of a computing apparatus or in a database. At operation 506 of example algorithm 500, a lookup table 508 of correlations between driving levels and configured emitted brightness values for a given brightness module (or a given brightness driver integrated circuit) is established and may be stored, e.g., in a memory device of a computing apparatus or in a database. Both of operations 502 and 506 may be performed offline.

Operation 514 of example algorithm 500 determines the desired emitted brightness value by taking as input a brightness level 510, e.g., provided by a system, as well as the table of desired emitted brightness value or the function of desired emitted brightness value. The determined desired emitted brightness value 514 and determined configured emitted brightness value from lookup table 508 are taken as input at operation 516, which determines an actual emitted brightness from the configured emitted brightness values according to the desired emitted brightness value and selects a driving level corresponding to the determined actual emitted brightness value according to the lookup table 508 for the given brightness module (or the given brightness driver integrated circuit) and computes a gain for adjusting, e.g., darkening or brightening, an image content for display. That is, the driving level selected in operation 516 may cause the actual emitted brightness value of the light outputted by a brightness module (e.g., brightness module 520) to be higher than, lower than or interleaved with the desired emitted brightness value as in chart 210, chart 310 or chart 410 in accordance with example scheme 200, example scheme 300 or example scheme 400, respectively. The selected driving level is provided to a brightness module 520, which is the given brightness module (or a given brightness driver integrated circuit) in example algorithm 500, to output or otherwise emit a light, e.g., backlight. The computed gain and an image content 512 for display are taken as input at operation 518, which adjusts the content brightness, e.g., darkening and/or brightening, of the image content 512 for display to provide a processed image content to a display module 522. That is, operation 518 adjusts the content brightness of the image content 512 for display in accordance with example scheme 200, example scheme 300 or example scheme 400, respectively. Display module 522 displays the processed image content. Operations 514, 516 and 518 as well as operations of the brightness module 520 and display module 522 may be performed during runtime.

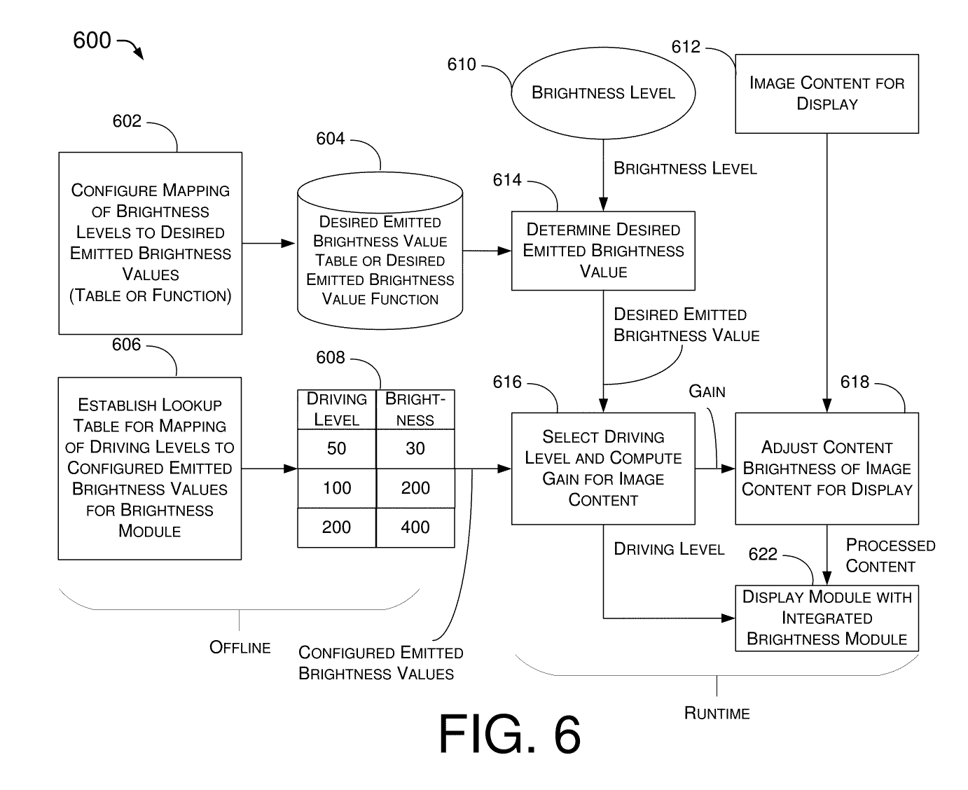

FIG. 6 illustrates an example algorithm 600 of brightness adjustment for display in accordance with an implementation of the present disclosure. Example algorithm 600 may involve one or more operations, actions, or functions as represented by one or more of operations 602, 604, 606, 608, 610, 612, 614, 616, 618 and 622. Although illustrated as discrete blocks, various blocks of example algorithm 600 may be divided into additional blocks, combined into fewer blocks, or eliminated, depending on the desired implementation. Example algorithm 600 may be implemented by example apparatus 700 described below.

Referring to FIG. 6, a portion of example algorithm 600 may be accomplished offline while another portion of example algorithm 600 may be accomplished during runtime. At operation 602 of example algorithm 600, brightness levels may be set in either a table of desired emitted brightness value or in a function of desired emitted brightness value. At operation 604 of example algorithm 600, the table of desired emitted brightness value or function of desired emitted brightness value may be stored, e.g., in a memory device of a computing apparatus or in a database. At operation 606 of example algorithm 600, a lookup table 608 of correlations between driving levels and configured emitted brightness values for a given display module (or a given display driver integrated circuit) is established and may be stored, e.g., in a memory device of a computing apparatus or in a database. Both of operations 602 and 606 may be performed offline.

Operation 614 of example algorithm 600 determines the desired emitted brightness value by taking as input a brightness level 610, e.g., provided by a system, as well as the table of desired emitted brightness value or the function of desired emitted brightness value. The determined desired emitted brightness value 614 and lookup table 608 are taken as input at operation 616, which determines an actual emitted brightness from the configured emitted brightness values according to the desired emitted brightness value and selects a driving level corresponding to the determined actual emitted brightness value according to the lookup table 608 for the given brightness module (or the given brightness driver integrated circuit) and computes a gain for adjusting, e.g., darkening or brightening, an image content for display. That is, the driving level selected in operation 616 may cause the actual emitted brightness value of the light outputted by a brightness module (e.g., an integrated brightness module of display module 622) to be higher than, lower than or interleaved with the desired emitted brightness value as in chart 210, chart 310 or chart 410 in accordance with example scheme 200, example scheme 300 or example scheme 400, respectively. The selected driving level is provided to a display module 622, which is the given display module (or a given display driver integrated circuit) in example algorithm 600, to output or otherwise emit a light. The computed gain and an image content 612 for display are taken as input at operation 618, which adjusts the content brightness, e.g., darkening and/or brightening, of the image content 612 for display to provide a processed image content to a display module 622. That is, operation 618 adjusts the content brightness of the image content 612 for display in accordance with example scheme 200, example scheme 300 or example scheme 400, respectively. Display module 622 displays the processed image content. Operations 614, 616 and 618 as well as operations of the brightness module 620 and display module 622 may be performed during runtime.

### Example Implementations

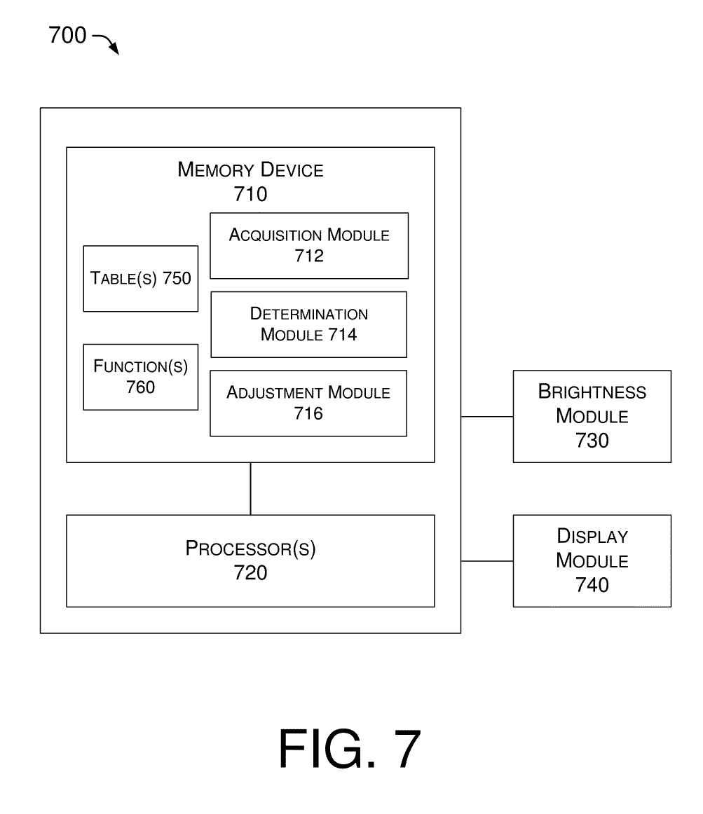

FIG. 7 illustrates an example apparatus 700 in accordance with an implementation of the present disclosure.

Example apparatus 700 may perform various functions related to schemes, techniques, processes and systems described herein, including Equations (1)-(5), example algorithms 500 and 600 described above as well as example processes 800, 900, 1000 and 1100 described below. In some implementations, example apparatus 700 may include at least those components shown in FIG. 7, such as a memory device 710 and one or more processors 720. Although memory device 710 and one or more processors 720 are depicted as discrete components separate from each other, in various implementations memory device 710 and one or more processors 720 may be integral parts of a single module in the form of an integrated circuit (IC), chip or chipset. Alternatively, memory device 710 and one or more processors 720 may be implemented as separate and discrete ICs or chips. Moreover, each of memory device 710 and one or more processors 720 may be implemented in the form of a physical circuit having a number of transistors, resistors, capacitors, inductors and/or memristors (and optional firmware, middleware, software, or any combination thereof) configured to perform the respective function(s) described herein. In some implementations, example apparatus 700 may be a part of or separate from (e.g., as a discrete IC) a backlight driver IC, a display control IC, or a controller, driver, processor or any IC associated with a LCD device.

In some implementations, such as the example shown in FIG. 7, example apparatus 700 may additionally include either or both of a brightness module 730 and a display module 740, the operations of which are controllable by the one or more processors 720. For instance, example apparatus 700 may be an electronic apparatus or a computing apparatus such as a smartphone, tablet computer, laptop computer, notebook computer, desktop computer, personal digital assistant, wearable computer, or the like. Brightness module 730 may be a backlight module similar to that in a LCD display device. Display module 740 may be a display module similar to that in a LCD display device. In some implementations, brightness module 730 may be an integral part, e.g., embedded in, display module 740.

Memory device 710 may be configured to store data as well as one or more sets of processor-executable instructions. The one or more sets of processor-executable instructions may be firmware, middleware, software or any combination thereof. In some implementations, memory unit 710 may store one or more tables 750 (e.g., lookup tables 504/508 and 604/608 and/or the table of desired emitted brightness values and configured brightness values) or one or more functions 760 (e.g., functions of desired emitted brightness values) as described above with respect to example algorithms 500 and 600. Memory device 710 may also store one or more other parameters for performing schemes, techniques and processes of the present disclosure including, for example, system-provided brightness level, value for determined desired emitted brightness value, selected driving level for brightness module, computed gain value, image content for display as described above with respect to example algorithms 500 and 600.

Memory device 710 may be in the form of any combination of one or more computer-usable or non-transitory computer-readable media. For example, memory device 710 may be in the form of one or more of a removable computer diskette, a hard disk, a random access memory (RAM) device, a read-only memory (ROM) device, an erasable programmable read-only memory (EPROM or Flash memory) device, a removable compact disc read-only memory (CDROM), an optical storage device, a magnetic storage device, or any suitable storage device. Computer program code for carrying out operations of the present disclosure may be written in any combination of one or more programming languages. Such code, or processor-executable instruction, may be compiled from source code to computer-readable assembly language or machine code suitable for the device or computer on which the code will be executed.

The one or more processors 720 may be coupled to memory device 710. One or more processors 720 may be configured to execute any of the one or more sets of processor-executable instructions to perform a number of operations, including those of including example algorithms 500 and 600 as well as example processes 800, 900, 1000 and 1100.

Memory device 710 may be coupled to the one or more processors 720 and configured to store a number of components executable by the one or more processors 720. In the example shown in FIG. 7, memory device 710 may store therein an acquisition module 712, a determination module 714 and adjustment module 716. Each of acquisition module 712, determination module 714 and an adjustment module 716 may be implemented in the form of software, middleware, firmware, or any combination thereof.

Acquisition module 712 may be configured to cause the one or more processors 720 to obtain a desired emitted brightness value for a brightness module or a display module implementable in a display device. The desired emitted brightness value may be between a first configured emitted brightness value and a second configured emitted brightness value of a plurality of configured emitted brightness values outputable by the brightness module. The second configured emitted brightness value may be higher than the first configured emitted brightness value. Additionally, acquisition module 712 may be configured to cause the one or more processors 720 to obtain a first emitted brightness value desired to be outputted by the brightness module.

Determination module 714 may be configured to cause the one or more processors 720 to determine a value of a driving level for driving the brightness module. The driving level may correspond to an actual emitted brightness value outputted by the display module or the brightness module. The actual emitted brightness value may be either the first configured emitted brightness value or the second configured emitted brightness value. Determination module 714 may be further configured to cause the one or more processors 720 to determine a gain for adjusting brightness of an image content outputted by the display module to compensate a difference between the desired emitted brightness value and the actual emitted brightness value. Additionally, determination module 714 may be configured to cause the one or more processors 720 to select, according to the first emitted brightness value and from a plurality of available emitted brightness values the backlight unit is capable of outputting, a second emitted brightness value to be outputted by the brightness module. In such instances, each of the available emitted brightness values may be different from the first emitted brightness value.

Adjustment module 716 may be configured to cause the one or more processors 720 to adjust the brightness of the image content outputted by the display module according to the gain. Additionally, adjustment module 716 may be configured to cause the one or more processors 720 to adjust a level of brightness of an image content outputted by the display module to compensate a difference between the first emitted brightness value and the second emitted brightness value outputted by the brightness module.

In some implementations, the one or more processors 720 may be further configured to determine the first configured emitted brightness value to be the actual emitted brightness value for each of different desired emitted brightness values. In some implementations, in response to determining the first configured emitted brightness value to be the actual emitted brightness value, the one or more processors 720 may be configured to increase the brightness of the image content outputted by the display module according to the gain.

In some implementations, the one or more processors 720 may be further configured to determine the second configured emitted brightness value to be the actual emitted brightness value for each of different desired emitted brightness values. In some implementations, in response to determining the second configured emitted brightness value to be the actual emitted brightness value, the one or more processors 720 may be configured to decrease the brightness of the image content outputted by the display module according to the gain.

In some implementations, the one or more processors 720 may be further configured to select the first configured emitted brightness value or the second configured emitted brightness value alternatively for different emitted brightness values.

In some implementations, the one or more processors 720 may be further configured to determine an in-between brightness level that is between the first configured emitted brightness value and the second configured emitted brightness value to be the actual emitted brightness value.

In some implementations, in determining the gain, the one or more processors 720 may be configured to determine the gain to be proportional to a ratio between the desired emitted brightness value and the actual emitted brightness value.

In some implementations, memory device 710 may be configured to store a lookup table indicative of correlations between a plurality of driving levels and a plurality of configured emitted brightness values associated with the brightness module. Moreover, in determining the driving level, the one or more processors 720 may be configured to identify the driving level corresponding to the determined actual emitted brightness value in the lookup table.

In some implementations, the one or more processors 720 may be further configured to obtain a desired brightness level and determine the desired emitted brightness value according to the desired brightness level.

In some implementations, memory device 710 may be configured to store a lookup table indicative of correlations between a plurality of brightness levels and a plurality of emitted brightness values. Additionally, in determining the desired emitted brightness value outputted by the brightness module, the one or more processors 720 may be configured to identify the desired emitted brightness value corresponding to the desired brightness level in the lookup table.

In some implementations, in determining the desired emitted brightness value outputted by the brightness module according to the desired brightness level, the one or more processors 720 may be configured to determine the desired emitted brightness value according to a preconfigured function defining correlations between a plurality of brightness levels and a plurality of emitted brightness values.

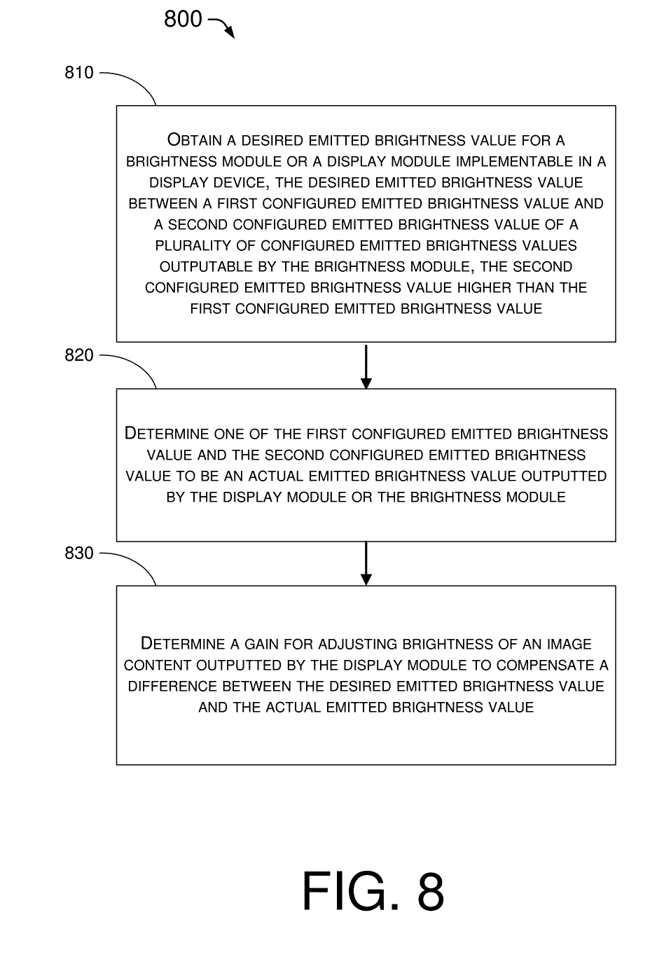

FIG. 8 illustrates an example process 800 of brightness adjustment for display in accordance with an implementation of the present disclosure.

Example process 800 may include one or more operations, actions, or functions as illustrated by one or more of blocks 810, 820 and 830. Although illustrated as discrete blocks, various blocks may be divided into additional blocks, combined into fewer blocks, or eliminated, depending on the desired implementation. Example process 800 may be implemented by example apparatus 700 or any variation thereof. For illustrative purposes, the operations described below are performed by the one or more processors 720 of example apparatus 700. Example process 800 may begin at 810.

At 810, example process 800 may involve the one or more processors 720 obtaining a desired emitted brightness value for a brightness module (e.g., brightness module 730) or a display module (e.g., display module 740), both of which may be implementable in a display device. The desired emitted brightness value may be between a first configured emitted brightness value and a second configured emitted brightness value of a plurality of configured emitted brightness values outputable by brightness module 730. The second configured emitted brightness value may be higher than the first configured emitted brightness value. Example process 800 may proceed from 810 to 820.

At 820, example process 800 may involve the one or more processors 720 determining one of the first configured emitted brightness value and the second configured emitted brightness value to be an actual emitted brightness value outputted by display module 740 or the brightness module 730. Example process 800 may proceed from 820 to 830.

At 830, example process 800 may involve the one or more processors 720 determining a gain for adjusting brightness of an image content outputted by display module 740 to compensate a difference between the desired emitted brightness value and the actual emitted brightness value.

In some implementations, example process 800 may further involve the one or more processors 720 determining the first configured emitted brightness value to be the actual emitted brightness value for each of different desired emitted brightness values. In some implementations, in response to determining the first configured emitted brightness value to be the actual emitted brightness value, example process 800 may involve the one or more processors 720 increasing the brightness of the image content outputted by the display module according to the gain.

In some implementations, example process 800 may further involve the one or more processors 720 determining the second configured emitted brightness value to be the actual emitted brightness value for each of different desired emitted brightness values. In some implementations, in response to determining the second configured emitted brightness value to be the actual emitted brightness value, example process 800 may involve the one or more processors 720 decreasing the brightness of the image content outputted by the display module according to the gain.

In some implementations, example process 800 may further involve the one or more processors 720 selecting the first configured emitted brightness value or the second configured emitted brightness value alternatively for different emitted brightness values.

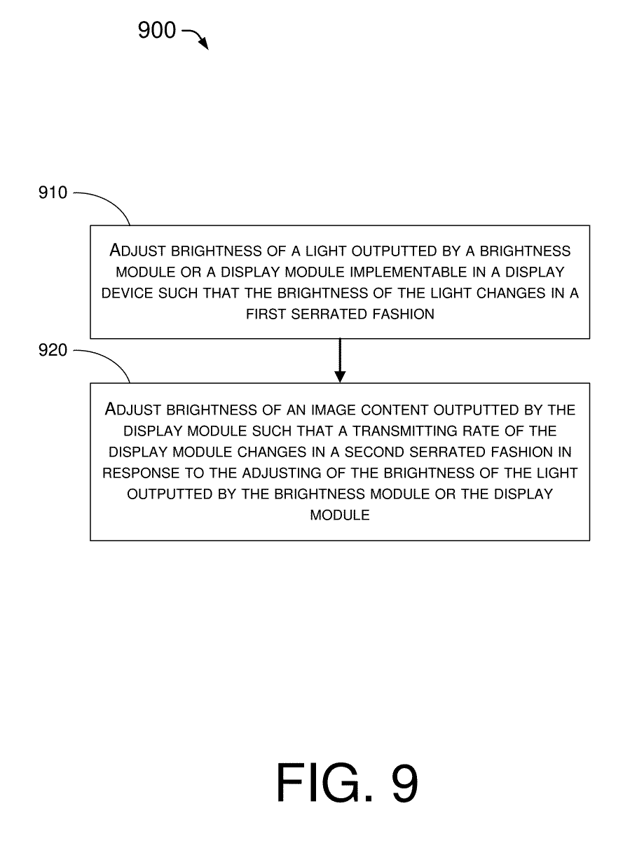

FIG. 9 illustrates an example process 900 of brightness adjustment for display in accordance with an implementation of the present disclosure.

Example process 900 may include one or more operations, actions, or functions as illustrated by one or more of blocks 910 and 920. Although illustrated as discrete blocks, various blocks may be divided into additional blocks, combined into fewer blocks, or eliminated, depending on the desired implementation. Example process 900 may be implemented by example apparatus 700 or any variation thereof. For illustrative purposes, the operations described below are performed by the one or more processors 720 of example apparatus 700. Example process 900 may begin at 910.

At 910, example process 900 may involve the one or more processors 720 adjusting brightness of a light outputted by a brightness module (e.g., brightness module 730) or a display module (e.g., display module 740), both of which being implementable in a display device, such that the brightness of the light changes in a first serrated fashion. Example process 900 may proceed from 910 to 920.

At 920, in response to the adjusting of the brightness of the light outputted by brightness module 730 or display module 740, example process 800 may involve the one or more processors 720 adjusting brightness of an image content outputted by display module 740 such that a transmitting rate of the display module changes in a second serrated fashion.

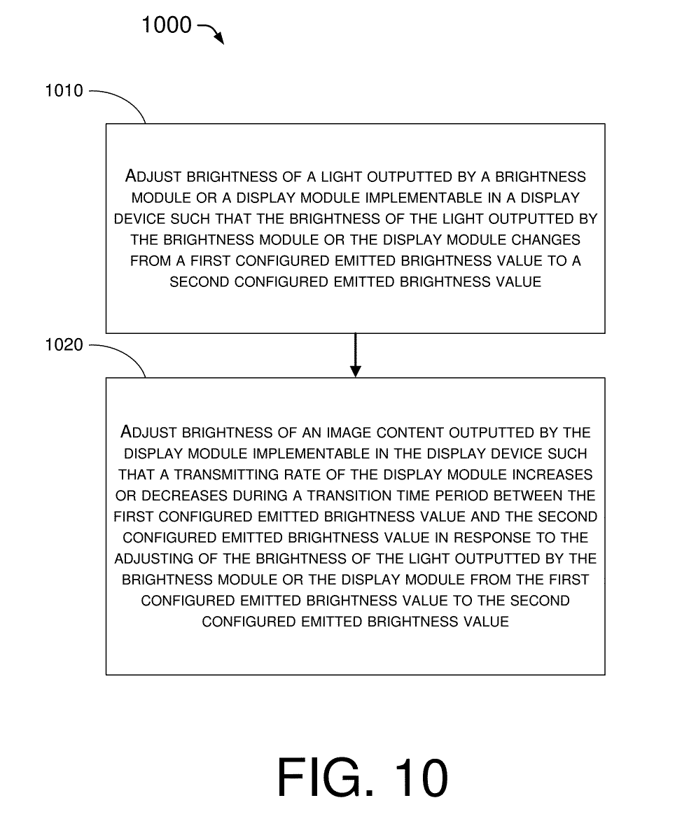

FIG. 10 illustrates an example process 1000 of brightness adjustment for display in accordance with an implementation of the present disclosure.

Example process 1000 may include one or more operations, actions, or functions as illustrated by one or more of blocks 1010 and 1020. Although illustrated as discrete blocks, various blocks may be divided into additional blocks, combined into fewer blocks, or eliminated, depending on the desired implementation. Example process 1000 may be implemented by example apparatus 700 or any variation thereof. For illustrative purposes, the operations described below are performed by the one or more processors 720 of example apparatus 700. Example process 1000 may begin at 1010.

At 1010, example process 1000 may involve the one or more processors 720 adjusting brightness of a light outputted by a brightness module (e.g., brightness module 730) or a display module (e.g., display module 740), both of which being implementable in a display device, such that the brightness of the light outputted by brightness module 730 or display module 740 changes from a first configured emitted brightness value to a second configured emitted brightness value. The first configured emitted brightness value and the second configured emitted brightness value may be two immediately adjacent configured emitted brightness values of a plurality of configured emitted brightness values of the brightness module. Example process 1000 may proceed from 1010 to 1020.

At 1010, in response to the adjusting of the brightness of the light outputted by brightness module 730 or display module 740 from the first configured emitted brightness value to the second configured emitted brightness value, example process 1000 may involve the one or more processors 720 adjusting brightness of an image content outputted by display module 740 such that a transmitting rate of display module 740 increases or decreases during a transition time period between the first configured emitted brightness value and the second configured emitted brightness value.

It is noted that similar compensation idea can be applied to a display device which contain a display module but does not contain a brightness module or backlight module, such as an AMOLED. In such embodiments, a driving signal input to the display module may have fewer levels than desired levels of the display module. Therefore, emitted brightness value of an image content can be adjusted to effectively achieve the desired levels.

Specifically, a method may include: obtaining a desired emitted brightness value for a display module or a brightness module implementable in a display device, the desired emitted brightness between a first configured emitted brightness value and a second configured emitted brightness value of a plurality of configured emitted brightness values of brightness, the second configured emitted brightness value higher than the first configured emitted brightness value; determining a driving level for driving the display module, the driving level corresponding to an actual emitted brightness value that is either the first configured emitted brightness value or the second configured emitted brightness value; and determining a gain value for adjusting brightness of an image content outputted by the display module to compensate the difference between the desired emitted brightness value and the actual emitted brightness value.

Furthermore, in more embodiments, a first emitted brightness value can be generated. The first emitted brightness value is limited to be one of a first plurality of allowable emitted brightness values. The first emitted brightness value, for example, can be associated with a driving level of a brightness module or a backlight module, or a driving level inputted to a display module, or a certain level input to at least a part of a display device. Than emitted brightness value of an image content outputted by the display module can then be compensated to effectively increase a brightness level of the display devices.

Since the compensation can effectively increase brightness levels of the display device, display quality can be enhanced even though driving levels of a brightness module or a backlight module and/or driving levels of a display module and/or any other part of a display device is limited.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
obtaining a desired emitted brightness value for a brightness module or a display module implementable in a display device, the desired emitted brightness value between a first configured emitted brightness value and a second configured emitted brightness value of a plurality of configured emitted brightness values outputable by the brightness module, the second configured emitted brightness value higher than the first configured emitted brightness value;
determining one of the first configured emitted brightness value and the second configured emitted brightness value to be an actual emitted brightness value outputted by the display module or the brightness module; and
determining a gain for adjusting brightness of an image content outputted by the display module to compensate a difference between the desired emitted brightness value and the actual emitted brightness value.

2. The method of claim 1, further comprising:
determining the first configured emitted brightness value to be the actual emitted brightness value for each of different desired emitted brightness values.

3. The method of claim 1, further comprising:
determining the second configured emitted brightness value to be the actual emitted brightness value for each of different desired emitted brightness values.

4. The method of claim 1, further comprising:
selecting the first configured emitted brightness value or the second configured emitted brightness value alternatively for different desired emitted brightness values.

5. The method of claim 1, wherein, in response to determining the first configured emitted brightness value to be the actual emitted brightness value, increasing the brightness of the image content outputted by the display module according to the gain.

6. The method of claim 1, wherein, in response to determining the second configured emitted brightness value to be the actual emitted brightness value, decreasing the brightness of the image content outputted by the display module according to the gain.

7. A method, comprising:
adjusting brightness of a light outputted by a brightness module or a display module implementable in a display device such that the brightness of the light changes in a first serrated fashion; and
in response to the adjusting of the brightness of the light outputted by the brightness module or the display module, adjusting brightness of an image content outputted by the display module such that a transmitting rate of the display module changes in a second serrated fashion.

8. A method, comprising:
adjusting brightness of a light outputted by a brightness module or a display module implementable in a display device such that the brightness of the light outputted by the brightness module or the display module changes from a first configured emitted brightness value to a second configured emitted brightness value, wherein the first configured emitted brightness value and the second configured emitted brightness value are two adjacent configured emitted brightness values of a plurality of configured emitted brightness values of the brightness module; and
in response to the adjusting of the brightness of the light outputted by the brightness module or the display module from the first configured emitted brightness value to the second configured emitted brightness value, adjusting brightness of an image content outputted by the display module such that a transmitting rate of the display module increases or decreases during a transition time period between the first configured emitted brightness value and the second configured emitted brightness value.

9. An apparatus, comprising:
one or more processors; and
a memory device coupled to the one or more processors and configured to store a plurality of components executable by the one or more processors, the plurality of components comprising:
an acquisition module configured to cause the one or more processors to obtain a desired emitted brightness value for a brightness module or a display module implementable in a display device, the desired emitted brightness value between a first configured emitted brightness value and a second configured emitted brightness value of a plurality of configured emitted brightness values outputable by the brightness module, the second configured emitted brightness value higher than the first configured emitted brightness value;
a determination module configured to cause the one or more processors to determine an actual emitted brightness value outputted by the display module or the brightness module, the actual emitted brightness value being determined to be either the first configured emitted brightness value or the second configured emitted brightness value, the determination module further configured to cause the one or more processors to determine a gain for adjusting brightness of an image content outputted by the display module to compensate a difference between the desired emitted brightness value and the actual emitted brightness value; and
an adjustment module configured to cause the one or more processors to adjust the brightness of the image content outputted by the display module according to the gain.

10. The apparatus of claim 9, wherein the one or more processors are further configured to determine the first configured emitted brightness value to be the actual emitted brightness value for each of different desired emitted brightness values.

11. The apparatus of claim 9, wherein the one or more processors are further configured to determine the second configured emitted brightness value to be the actual emitted brightness value for each of different desired emitted brightness values.

12. The apparatus of claim 9, wherein the one or more processors are further configured to select the first configured emitted brightness value or the second configured emitted brightness value alternatively for different desired brightness values.

13. The apparatus of claim 10, wherein, in response to determining the first configured emitted brightness value to be the actual emitted brightness value, the one or more processors are configured to increase the brightness of the image content outputted by the display module according to the gain.

14. The apparatus of claim 11, wherein, in response to determining the second configured emitted brightness value to be the actual emitted brightness value, the one or more processors are configured to decrease the brightness of the image content outputted by the display module according to the gain.

15. The apparatus of claim 9, wherein the one or more processors are further configured to determine an in-between brightness level that is between the first configured emitted brightness value and the second configured emitted brightness value to be the actual emitted brightness value.

16. The apparatus of claim 9, wherein, in determining the gain, the one or more processors are configured to determine the gain to be proportional to a ratio between the desired emitted brightness value and the actual emitted brightness value.

17. The apparatus of claim 9, wherein the memory device is further configured to store a lookup table indicative of correlations between a plurality of driving levels and a plurality of configured emitted brightness values associated with the brightness module, and the one or more processors are configured to identify a driving level corresponding to the determined actual emitted brightness value in the lookup table.

18. The apparatus of claim 9, wherein the one or more processors are further configured to perform operations comprising:
obtaining a desired brightness level; and
determining the desired emitted brightness value according to the desired brightness level.

19. The apparatus of claim 18, wherein the memory device is configured to store a lookup table indicative of correlations between a plurality of emitted brightness values and a plurality of brightness levels, and wherein, in determining the desired emitted brightness value according to the desired brightness level, the one or more processors are configured to identify the desired emitted brightness value in the lookup table.

20. The apparatus of claim 18, wherein, in determining the emitted brightness according to the desired brightness level, the one or more processors are configured to determine the emitted brightness value according to a preconfigured function defining correlations between a plurality of brightness levels and a plurality of emitted brightness values outputted by the brightness module.
